(19) United States
(12) Patent Application Publication
(10) Pub. No.: US 2026/0289756 A1
(43) Pub. Date: Sep. 24, 2026

(54) VIDEO DIRTY-SPOT DETECTION METHOD AND DEVICE, AND ELECTRONIC DEVICE

(71) Applicant: BOE Technology Group Co., Ltd., Beijing (CN)

(72) Inventor: Ran DUAN, Beijing (CN)

(21) Appl. No.: 18/996,054

(22) PCT Filed: Mar. 27, 2023
(86) PCT No.: PCT/CN2023/084049

§ 371 Date: Jan. 17, 2025

(51) Int. Cl. G06T 7/00; G06T 5/20; G06T 5/50; G06T 5/70; G06T 5/77; G06V 10/28; G06V 10/74

(52) U.S. Cl. CPC G06T 7/0002; G06T 5/20; G06T 5/50; G06T 5/70; G06T 5/77; G06V 10/28; G06V 10/761; G06T 2207/10016; G06T 2207/20021; G06T 2207/20032

(57) ABSTRACT

A video dirty-spot detection method and device, and an electronic device. The method includes: acquiring reference frames corresponding to the current image frame in a video, wherein the reference frames include the previous reference frame and the next reference frame, the previous reference frame being an image frame before the current image frame in the video, and the next reference frame being an image frame after the current image frame in the video; performing filtering processing on the current image frame, and the previous reference frame and next reference frame, which correspond to the current image frame, to obtain filtered image frames; and according to respective similarities between the filtered image frames and the current image frame, and the previous reference frame and next reference frame, determining whether there is a dirty spot in the current image frame.

### CROSS REFERENCE TO RELATED APPLICATIONS

The present disclosure is a national phase entry under 35 U.S.C § 371 of International Application No. PCT/CN2023/084049, filed on Mar. 27, 2023, the entire contents of which are incorporated herein by reference.

### TECHNICAL FIELD

The present disclosure relates to the technical field of image processing, in particular to a method, device and electronic device for detecting a dirty spot in a video.

### BACKGROUND

As a kind of video damage, dirty spots refer to areas where image information is missing or areas where image information is blocked in image frames of the video. The dirty spots are usually represented as a connected area in the image frame. The connected area destroys original image information in the image frame, and the connected area is usually a white or black block spot or a strip black line, and the dirty spot also has randomness.

At present, deep learning methods can be used to remove and repair dirty spots, but in practical applications, configuration requirements for the use of devices are higher, and more applications are deployed in AI server devices, which is costly. Although the end-to-end deep learning method makes it easier for users to get started, because of its limited hyper-parameters, it is difficult to flexibly adjust when dealing with scenarios such as different frame rates, different resolutions, and different sizes and colors of dirty spots, and needs to use data from similar scenes for retraining or fine-tuning, which requires repeated development according to the scenes.

### SUMMARY

The present disclosure provides a method, device and electronic device for detecting a dirty spot in a video, which is used for using various traditional operation methods in the field of image processing, does not rely on deep learning framework, and carries out local detection of dirty spot areas based on the similarity of adjacent image frames, effectively reducing the complexity of operation, and improving the flexibility of detection.

In a first aspect, embodiments of the present disclosure provide a method for detecting a dirty spot in a video, including:

obtaining a reference frame corresponding to a current image frame in the video, where the reference frame comprises a front reference frame and a back reference frame, the front reference frame is an image frame before the current image frame in the video, and the back reference frame is an image frame after the current image frame in the video;
filtering the current image frame, the front reference frame corresponding to the current image frame and the back reference frame corresponding to the current image frame to obtain filtered image frames; and determining whether there is the dirty spot in the current image frame according to a similarity of a corresponding one of the filtered image frames to the current image frame, a similarity of a corresponding one of the filtered image frames to the front reference frame corresponding to the current image frame and a similarity of a corresponding one of the filtered image frames to the back reference frame corresponding to the current image frame.

In a second aspect, embodiments of the present disclosure provide a device for detecting a dirty spot in a video, including a processor and a memory, the memory is configured to store programs executable by the processor, and the processor is configured to read the programs in the memory and perform following steps:
in response to a user's input operation of at least one of a time parameter, a similarity parameter, a similarity threshold, a preset window size, or a preset step size, and detecting the dirty spot in an image frame in the video according to parameters corresponding to the input operation based on any of the methods described in the first aspect;
where the time parameter represents a quantity of frames between the current image frame and the reference frame of the current image frame; the similarity parameter represents a range of a local area that affects a structural similarity of pixels at the same position in two image frames when calculating an average structural similarity by using the structural similarity of pixels at the same position in two image frames.

In a third aspect, embodiments of the present disclosure provide an electronic device including a processor and a memory, the memory is configured to store programs executable by the processor, and the processor is configured to read the programs in the memory and perform following steps:
obtaining a reference frame corresponding to a current image frame in the video, where the reference frame includes a front reference frame and a back reference frame, the front reference frame is an image frame before the current image frame in the video, and the back reference frame is an image frame after the current image frame in the video;
filtering the current image frame, the front reference frame corresponding to the current image frame and the back reference frame corresponding to the current image frame to obtain filtered image frames; and determining whether there is the dirty spot in the current image frame according to a similarity of a corresponding one of the filtered image frames to the current image frame, a similarity of a corresponding one of the filtered image frames to the front reference frame corresponding to the current image frame and a similarity of a corresponding one of the filtered image frames to the back reference frame corresponding to the current image frame.

In a fourth aspect, embodiments of the present disclosure further provide an apparatus for detecting a dirty spot in a video, including:
an obtaining unit configured to obtain a reference frame corresponding to a current image frame in the video, where the reference frame includes a front reference frame and a back reference frame, the front reference frame is an image frame before the current image frame in the video, and the back reference frame is an image frame after the current image frame in the video;
a filter unit configured to filter the current image frame, the front reference frame corresponding to the current image frame and the back reference frame corresponding to the current image frame to obtain filtered image frames;
a determining unit configured to determine whether there is a dirty spot in the current image frame according to a similarity of a corresponding one of the filtered image frames to the current image frame, a similarity of a corresponding one of the filtered image frames to the front reference frame corresponding to the current image frame and a similarity of a corresponding one of the filtered image frames to the back reference frame corresponding to the current image frame.

In a fifth aspect, embodiments of the present disclosure further provide a computer storage medium, in which computer programs are stored, wherein steps of any one of the methods according to the first aspect are implemented when the computer programs are executed by a processor

These or other aspects of the present disclosure will be more concise and understandable in the following embodiments.

### BRIEF DESCRIPTION OF FIGURES

In order to more clearly illustrate the technical solutions in the embodiments of the present disclosure, the drawings required in the description of the embodiments will be briefly introduced below, and it is obvious that the drawings in the following description are only some embodiments of the present disclosure, and for those skilled in the art, other drawings can also be obtained according to these drawings without creative labor.

FIG. 1 is an implementation flow chart of a method for detecting a dirty spot in a video provided by embodiments of the present disclosure.

FIG. 2 is a schematic diagram of extracting a reference frame provided by embodiments of the present disclosure.

FIG. 3 is a schematic diagram of a median filtering algorithm provided by embodiments of the present disclosure.

FIG. 4 is a schematic diagram of cutting an image frame into blocks provided by embodiments of the present disclosure.

FIG. 5A-FIG. 5D are comparative schematic diagrams of median filtering provided by embodiments of the present disclosure.

FIG. 6 is a flow chart of automatic positioning of dirty spots provided embodiments of the present disclosure.

FIG. 7 is a schematic diagram of a change relationship between a similarity matrix and w provided by embodiments of the present disclosure.

FIG. 8 is a schematic diagram of a binary image changed with v provided by embodiments of the present disclosure.

FIG. 9 is a schematic diagram of a change of a binary image during a corrosion-expansion processing process provided by embodiments of the present disclosure.

FIG. 10 is a schematic diagram of a process of repairing a dirty spot provided by embodiments of the present disclosure.

FIG. 11 is a flow chart of detecting and repairing a dirty spot in a video provided by embodiments of the present disclosure.

FIG. 12 is a schematic diagram of a flow of a detection and repair algorithm provided by embodiments of the present disclosure.

FIG. 13 is a schematic diagram of a device for detecting a dirty spot in a video provided by embodiments of the present disclosure.

FIG. 14 is a schematic diagram of an electronic device provided by embodiments of the present disclosure.

FIG. 15 is a schematic diagram of an apparatus for detecting a dirty spot in a video provided by embodiments of the present disclosure.

### DETAILED DESCRIPTION

In order to make the purpose, technical solution and advantages of the present disclosure more clear, the present disclosure will be described in further detail below in conjunction with the accompanying drawings, obviously, the described embodiments are only part of the embodiments of the present disclosure, not all embodiments. Based on the embodiments in the present disclosure, all other embodiments obtained by a person skilled in the art without making creative work belong to the protection scope of the present disclosure.

In the embodiments of the present disclosure, the term “and/or” describes the association relationship of associated objects, indicating that there can be three kinds of relations, for example, A and/or B, which can be expressed: the existence of A alone, the existence of A and B at the same time, and the existence of B alone. The character “/” generally indicates that the relationship between the preceding and posting objects is an “or” relationship.

The application scenario described in the embodiments of the present disclosure is to more clearly illustrate the technical solutions of the embodiments of the present disclosure, and does not constitute a limitation on the technical solutions provided in the embodiments of the present disclosure. In the description of the present disclosure, unless otherwise indicated, “plurality” or “multiple” means two or more of them.

As a kind of video damage, dirty spots refer to areas where image information is missing or areas where image information is blocked, in the image frame of the video, and the dirty spots usually appear as a connected area in the image frame, and the connected area destroys original image information in the image frame, and the connected area is usually white or black block spots or strip black lines. In addition, the dirty spots also have randomness, that is, the dirty spots appear randomly in the video.

The formation of dirty spots can be derived from film damage, and can also be caused by other factors. The present embodiments do not make too many restrictions on the cause of the formation of dirty spots. Taking film damage as an example, in the process of storage and use of film, due to the effect of static electricity, dust, hair and other fibers in the air may fall and adsorb on the film, if it is not cleaned in time during use, such dirty spots will become a part of the film copy. In the projection process, the dirty spots on the film often appear as white or black block-shaped spots in the video. In addition, if the film itself is damaged by scratches or bad bands, it will also cause dirty spots during video display due to the impact of scratches and bad bands during screening. The dirty spots generally have the following three features.

Feature 1: the gray variance of pixels inside the dirty spots is very small, and the gray scale in the block is basically the same, which is usually visually manifested as a black or white irregular color block.

Feature 2: the gray scale of dirty spots in time and spatial domains is not continuous. Because this damage is randomly distributed within one frame, and the probability of dirty spots repeating in the same location in two adjacent frames is lower, it appears as a pulsed damage in the time domain, i.e., flickering during video playback. In a frame of image, the gray scale of the dirty spot area is generally quite different from the gray scale of the surrounding background, so that it can be perceived by the human eye.

Feature 3: the dirty spots are spatially adjacent. That is, if a pixel is in a dirty spot, then the pixels around it are also likely to belong to the dirty spot area, that is, the dirty spot is not a single pixel, but a region.

At present, deep learning methods can be used to remove and repair dirty spots, but in practical applications, the configuration requirements for the use of devices are higher, and more applications are deployed in AI server devices, which is costly. Although the end-to-end deep learning method makes it easier for users to get started, because of its limited hyper-parameters, it is difficult to flexibly adjust when dealing with scenarios such as different frame rates, different resolutions, and different sizes and colors of dirty spots, and needs to use data from similar scenes for retraining or fine-tuning, which requires repeated development according to the scenes.

The present embodiments provide a method for detecting a dirty spot in a video, using various traditional computing methods in the field of image processing, without relying on deep learning frameworks, and can be deployed on a CPU computer device without GPU computing resources, and can also be used in a mobile terminal or a display terminal with better performance. The embodiments are used to detect dirty spots in the video according to the features of the dirty spots. Because the dirty spots have discontinuity in the time domain, and the contents of two adjacent frames in the same scene in the video are usually continuous, that is, pixel values of adjacent two frames at the same position are usually similar, so the present disclosure uses adjacent frames before and after a current frame in the video frame sequence as reference frames to automatically detect and repair the dirty spots in the current frame.

It should be noted that the method for detecting the dirty spot in the video provided in the present embodiments is used for detecting and repairing the dirty spots in the video. The dirty spots in the present embodiments are used to indicate the video damage with the above three features of the dirty spots, and the other video damage that is not called dirty spots but has the above three features of the dirty spots can also be detected and repaired by using the method of the present disclosure, and also belongs to the protection scope of the present disclosure.

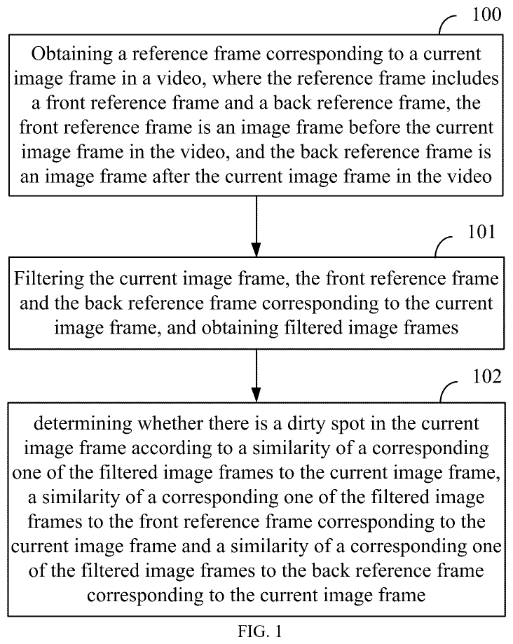

As shown in FIG. 1, the implementation flow of a method for detecting a dirty spot in a video provided in the present embodiments is as follows:

Step 100, obtaining a reference frame corresponding to a current image frame in the video, where the reference frame includes a front reference frame and a back reference frame, the front reference frame is an image frame before the current image frame in the video, and the back reference frame is an image frame after the current image frame in the video.

Optionally, the front reference frame in the present embodiments is one or more image frames before the current image frame in the video, and the back reference frame is one or more image frames after the current image frame in the video. When the front reference frame includes a plurality of image frames, the plurality of image frames are continuous in the video, and when the back reference frame includes a plurality of image frames, the plurality of image frames are also continuous in the video.

In the implementation, except for the first frame in the video, each image frame is obtained, the front reference frame and the back reference frame corresponding to the image frame are determined. When the first frame in the video is obtained, the first frame may not be processed. The detection may be started after the second frame is obtained.

In some embodiments, the front reference frame and the current image frame in the present embodiments are spaced by n image frames, where n is determined based on the number of frames in which dirty spots occur continuously in successive image frames, and n is an integer greater than or equal to 0; and/or, the back reference frame and the current image frame are spaced by m image frames, where m is determined based on the number of frames in which dirty spots occur continuously in successive image frames, and m is an integer greater than or equal to 0.

Optionally, n and m in the present embodiments are usually set to the same, and n and m can also be set to different values according to the actual features of the dirty spots. The present embodiments do not make too many restrictions on this. In the present embodiments, n is usually set to 0, when the dirty spots appear continuously in a plurality of image frames, the value of n can also be appropriately increased according to the number of frames in which the dirty spots appear continuously in successive image frames. Similarly, m in the present embodiments is usually set to 0, and the value of m can also be appropriately increased according to the number of frames in which the dirty spots appear continuously in successive image frames.

In the implementation, because the dirty spots have discontinuity in the time domain, and the content of two adjacent frames of the video in the same scene is usually continuous, the existence of dirty spots in the current image can be determined based on the similarity of the current image frame and the adjacent frames before and after, that is, the front reference frame and the current image frame are separated by 0 image frame at this time, that is, the front reference frame and the current image frame are adjacent, and the back reference frame and the current image frame are separated by 0 image frame, that is, the back reference frame and the current image frame are adjacent. The front and back reference frames are two adjacent images before and after the current image frame. In the time domain, the difference between the front reference frame and the current image frame is 1 time interval, and similarly, the difference between the back reference frame and the current image frame is 1 time interval. The time interval represents the time difference between two adjacent frames.

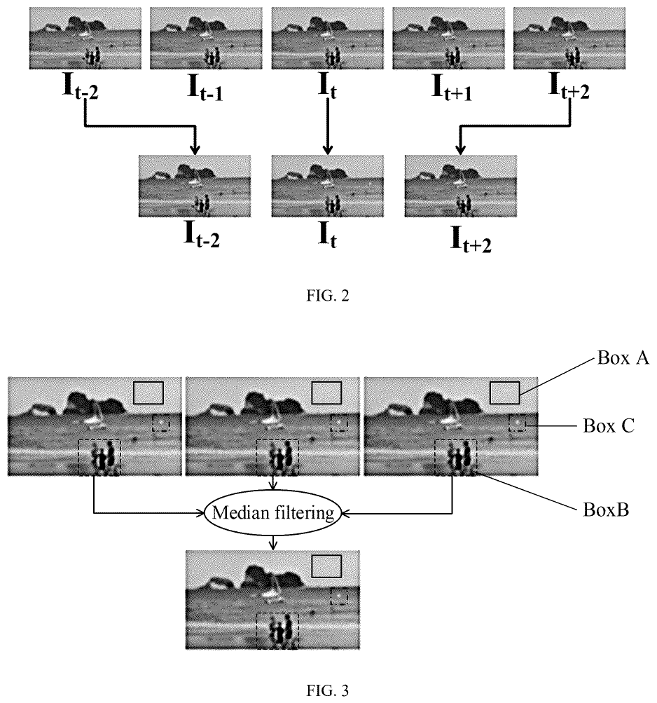

If abnormal dirty spots exist in the same position of multiple frames of images consecutively, the value of n can be increased according to the number of frames in which the abnormal dirty spots appear in consecutive image frames until the reference frame no longer contains dirty spots at the same position. As shown in FIG. 2, the present embodiments provide a schematic diagram for extracting reference frames, where Iₜ represents the current image frame, Iₜ₋₁ represents a previous adjacent image frame, i.e., an image frame that is one time interval away from the current image frame, Iₜ₋₂ represents a previous image frame that is two time intervals away from the current image frame. Iₜ₊₁ represents a next adjacent image frame, and Iₜ₊₂ represents a next image frame that is two time intervals away from the current image frame. When dirty spots appear in successive adjacent frames, that is, when dirty spots appear in all Iₜ₋₁, Iₜ, and Iₜ₊₁, it can set n=1, the interval between the front reference frame and the current image frame is 1 image frame, and the interval between the back reference frame and the current image frame is also 1 image frame, that is, Iₜ₋₂ and Iₜ₊₂ are extracted as the front reference frame of the current image frame and the back reference frame of the current image frame, and Iₜ₋₂ and Iₜ₊₂ have no dirty spots at this time, and the dirty spots in the current image frame can be detected by using these two reference frames.

In the implementation, for the continuous image frame in the video, when processing the dirty spots existing in the current frame, it is necessary to refer to the pixel value of the same position in the adjacent frames to fill in and repair, and the interval n and interval m are introduced as time parameters in this processing. Taking the image frame Iₜ corresponding to the time node t as an example, while extracting this image frame, it is also necessary to extract the reference frames Iₜ₋₍ₙ₊₁) and Iₜ₊₍ₘ₊₁₎ which are n image frames before the image frame Iₜ and m image frames after the image frame Iₜ. The values of intervals n and m are relevant to the occurrence rule of dirty spots in the video, and can be set after user's observation. As described in the conventional features of the above-mentioned dirty spots, most of the dirty spots generally do not appear in the same position of the continuous video frame sequence, so the values of n and m can usually be 0 to meet the requirements. If the abnormal dirty spots exist in the same position in multiple frames continuously, the values of n and m can be increased as appropriate until the reference frame no longer contains the dirty spots at the same position.

Step 101, filtering the current image frame, the front reference frame corresponding to the current image frame and the back reference frame corresponding to the current image frame to obtain filtered image frames.

Step 102, determining whether there is a dirty spot in the current image frame according to a similarity of a corresponding one of the filtered image frames to the current image frame, a similarity of a corresponding one of the filtered image frames to the front reference frame corresponding to the current image frame and a similarity of a corresponding one of the filtered image frames to the back reference frame corresponding to the current image frame.

In the implementation, the method for detecting a dirty spot provided in the present embodiments performs dirty spot detection in the unit of image frame, and after extracting the front reference frame of the current image frame and the back reference frame of the current image frame, each extracted image frame can be filtered respectively to obtain a corresponding filtered image frame. Based on a size relationship between similarities of the filtered image frame and each extracted image frame, whether there is a dirty spot in the current image frame is determined.

In some embodiments, the filtering algorithm is used to filter the current image frame, the front reference frame corresponding to the current image frame and the back reference frame corresponding to the current image frame to obtain the filtered image frames.

Optionally, the filtering algorithm in the present embodiments includes, but is not limited to, a time median filtering algorithm or a time mode filtering algorithm. The time median filtering algorithm is used for obtaining a median value of pixels at the same position in multiple frames of images, that is, obtaining a median value of pixels of the current image frame, the front reference frame and the back reference frame at the same position. The time mode filtering algorithm is used for obtaining the same pixel value of the largest quantity from pixel values at the same position in multiple frames of images, i.e., the mode in the pixel values of the current image frame, the front reference frame and the back reference frame at the same position, that is, the same pixel values of the largest quantity from pixel values of the same position.

In the implementation, the median filtering algorithm can be used to calculate the filtered image frame of the current image frame, the front reference frame corresponding to the current image frame and the back reference frame corresponding to the current image frame. The calculation process is shown in the following formula:

$${I}_{mid} ( i , j ) = {f}_{median} ( {I}_{t - ( n + 1 )} ( i , j ) , {I}_{t} ( i , j ) , {I}_{t + ( m + 1 )} ( i , j ) ) . \qquad Formula ( 1 a )$$

In the formula (1a), I_{mid} (i, j) represents the filtered image frame, Iₜ₋₍ₙ₊₁₎ (i, j) represents the front reference frame, Iₜ (i, j) represents the current image frame, Iₜ₊₍ₘ₊₁₎ (i, j) represents the back reference frame, n represents the number of frames between the current image frame and the front reference frame, m represents the number of frames between the current image frame and the back reference frame, (i, j) represents coordinates of pixels in an image block(s), and f_{median} (x, y, z) represents the calculation of the median of x, y, z, i.e., the formula (1a) is used to find the median of pixel values at each of the same positions in the front reference frame, the current reference frame, and the back reference frame.

As shown in FIG. 3, the present embodiments provide a schematic diagram of a median filtering algorithm. The box A represents that there are no dirty spots in the current image frame and the reference frame, and there are still no dirty spots after median filtering, and because the scene in the box A is relatively uniform, the original image structure is not destroyed after median filtering. The box B represents that there are no dirty spots in the current image frame and the reference frame, and there are still no dirty spots after median filtering, and the scene in box B is in motion, and the structure of the current image is changed after median filtering. The Box C represents that there are dirty spots in the current image frame, no dirty spots in the reference frame, and no dirty spots after median filtering.

In some embodiments, whether there is a dirty spot in the current image frame is determined based on the similarity of the current image frame and the reference frame by the following steps:

Step 1) determining the maximum similarity from the similarities of the filtered image frame to the front reference frame and the back reference frame respectively.

Optionally, the similarity in the present embodiments is used to represent the correlation between pixels of different image frames, including, but not limited to, structural similarity and/or average structural similarity.

In the implementation, the structural similarity is calculated by the following formula:

$$SSIM ( x , y ) = \frac{( 2 \times μ ( x ) \times μ ( y ) + {c}_{1} ) ( σ ( x , y ) + {c}_{2} )}{( {μ ( x )}^{2} + {μ ( y )}^{2} + {c}_{1} ) ( {σ ( x )}^{2} + {σ ( y )}^{2} + {c}_{2} )} ; \qquad Formula ( 2 a )$$

$$where , μ ( x ) = \frac{1}{H \times W \times C} {\sum }_{i = 1}^{H} {\sum }_{j = 1}^{W} {\sum }_{k = 1}^{C} x ( i , j , k ) ;$$

$$μ ( y ) = \frac{1}{H \times W \times C} {\sum }_{i = 1}^{H} {\sum }_{j = 1}^{W} {\sum }_{k = 1}^{C} y ( i , j , k ) ;$$

$$σ ( x ) = \sqrt{\frac{1}{H \times W \times C} {\sum }_{i = 1}^{H} {\sum }_{j = 1}^{W} {\sum }_{k = 1}^{C} {( x ( i , j , k ) - μ ( x ) )}^{2}} ;$$

$$σ ( y ) = \sqrt{\frac{1}{H \times W \times C} {\sum }_{i = 1}^{H} {\sum }_{j = 1}^{W} {\sum }_{k = 1}^{C} {( x ( i , j , k ) - μ ( y ) )}^{2}} ;$$

$$σ ( x , y ) = \frac{1}{H \times W \times C} {\sum }_{i = 1}^{H} {\sum }_{j = 1}^{W} {\sum }_{k = 1}^{C} ( x ( i , j , k ) - μ ( x ) ) ( y ( i , j , k ) - μ ( y ) ) .$$

The SSIM(x, y) in the formula (2a) represents the structural similarity of image frame x and image frame y; μ (x) and μ (y) represent an average value of image frame x and image frame γ, respectively; σ (x) and σ (y) represent a standard deviation of image frame x and image frame y; σ (x, y) represents the covariance of image frame x and image frame y, c₁=6.5025, c₂=58.5225; and H, W, and C represent the height, width, and number of channels of image frame x or image frame y respectively (usually the image is an RGB image, and the value is 3). In the present embodiments, the height, width, and number of channels of the two image frames for obtaining structural similarity are the same.

Step 2) determining whether there is a dirty spot in the current image frame according to a comparison result of the maximum similarity and the similarity of the filtered image frame to the current image frame.

In the implementation, the structural similarity between the filtered image frame I_{mid} and the previous reference frame Iₜ₋₍ₙ₊₁₎ is denoted as S1. The structural similarity between the filtered image frame I_{mid} and the back reference frame Iₜ₊₍ₘ₊₁₎ is denoted as S2. The structural similarity between the filtered image frame I_{mid} and the current image frame Iₜ is denoted as S0.

In some embodiments, if the similarity of the filtered image frame to the current image frame is less than the maximum similarity, it is determined that there is a dirty spot in the current image frame.

If the similarity of the filtered image frame to the current image frame is greater than or equal to the maximum similarity, it is determined that there is no dirty spot in the current image frame.

In the implementation, if S0<max(S1, S2), it is determined that there is a dirty spot in the current image frame;
if S0≥max(S1, S2), it is determined that there is no dirty spot in the current image frame.

In some embodiments, when the reference frame is a plurality of consecutive image frames, the present embodiments may also perform any one or more of the following:
(1) if the front reference frame is a plurality of continuous image frames before the current image frame in the video, determining the maximum similarity from the similarities of the filtered image frame to each front reference frame and the back reference frame respectively; determining whether there is a dirty spot in the current image frame according to the comparison result of the maximum similarity and the similarity of the filtered image frame to the current image frame;
(2) if the back reference frame is a plurality of continuous image frames after the current image frame in the video, determining the maximum similarity from the similarities of the filtered image frame to the front reference frame and each back reference frame respectively; determining whether there is a dirty spot in the current image frame according to the comparison result of the maximum similarity and the similarity of the filtered image frame to the current image frame;
(3) if the front reference frame is a plurality of continuous image frames before the current image frame in the video, and the back reference frame is a plurality of continuous image frames after the current image frame in the video, determining the maximum similarity from the similarities of the filtered image frame to each front reference frame and each back reference frame, respectively; determining whether there is a dirty spot in the current image frame according to the comparison result of the maximum similarity and the similarity of the filtered image frame to the current image frame.

In some embodiments, in order to preliminarily coarsely locate a dirty spot area, limit a dirty spot judgment range to a smaller image block, and avoid being more affected by a motion artifact area than the dirty spot area when calculating the structural similarity, resulting in inaccurate judgment, the present embodiments further provide a method for performing dirty spot detection in blocks, that is, performing dirty spot detection in the unit of image block.

Optionally, before filtering the current image frame, the front reference frame and the back reference frame corresponding to the current image frame by using the filtering algorithm to obtain the filtered image frames, the current image frame, the front reference frame and the back reference frame are respectively cut into a plurality of current image blocks, a plurality of front reference blocks and a plurality of back reference blocks. For each current image block, the filtering algorithm is used to filter the current image block, the front reference block and the back reference block corresponding to the current image block, to obtain the filtered image block. Whether there is a dirty spot in the current image block is determined according to the similarity of the filtered image block to the current image block, the similarity of the filtered image block to the front reference block and the similarity of the filtered image block to the back reference block, respectively.

In the implementation, the present embodiments can obtain the current image frame and the corresponding reference frame, and then divide the current image frame and the reference frame into blocks respectively, and then use the filtering algorithm such as a median filtering algorithm to calculate the filtered image block according to the current image block, the corresponding front reference block and the back reference block, and determine whether there is a dirty spot in the current image block according to the similarities of the filtered image block to the current image block, the front reference block and the back reference block, respectively.

Optionally, after using the filtering algorithm to filter the current image frame, the front reference frame and the back reference frame corresponding to the current image frame to obtain the filtered image frames, the current image frame, the front reference frame, the back reference frame and the filtered image frame are respectively cut into a plurality of current image blocks, a plurality of front reference blocks, a plurality of back reference blocks and a plurality of filtered image blocks; whether there is a dirty spot(s) in the current image block(s), according to the similarities of the filtered image block(s) to the current image block(s), the front reference block(s) and the back reference block(s) corresponding to the filtered image block(s), respectively.

It should be noted that when calculating the similarity, the positions of the filtered image blocks, the current image blocks, the front reference blocks, and the back reference blocks in their respective image frames are the same.

In some embodiments, in order to ensure that each image block obtained after dividing does not lose information of an original image frame, the image block also possesses the following characteristics:
two current image blocks closest to each other in a preset direction partially overlap, two front reference blocks closest to each other in the preset direction partially overlap, and two back reference blocks closest to each other in the preset direction partially overlap; and the preset direction comprises a horizontal axis direction or a vertical axis direction.

In some embodiments, the image frame can be cut to obtain image blocks by the following steps:
traversing the current image frame, the front reference frame and the back reference frame respectively by using the preset window according to a preset step size, and cutting out the plurality of current image blocks of a size same as the size of the preset window, the plurality of front reference blocks of a size same as the size of the preset window and the plurality of back reference blocks of a size same as the size of the preset window;
the preset step size includes a horizontal step size in the horizontal direction and a vertical step size in the vertical direction, the horizontal step size is less than or equal to a width of the preset window, and the vertical step size is less than or equal to a height of the preset window.

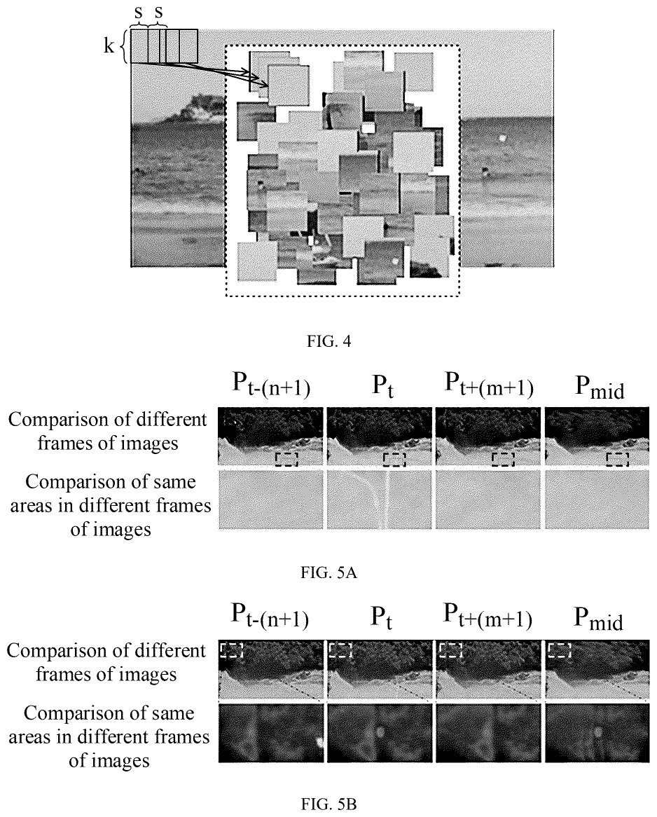

In the implementation, the preset window can be a square or a rectangle, in order to reduce the amount of operation parameters, the preset window can be set to a square, and a preset step size can be set at this time, for example, for the extracted three image frames (the front reference frame Iₜ₋₁, the current image frame Iₜ, and the back reference frame Iₜ₊₁), they are respectively cut and divided into blocks according to the space step size s and the window side length k (the width/height of the square), and the image blocks corresponding to the same position of Iₜ₋₁, Iₜ, Iₜ₊₁ are divided into a group. Several groups of image blocks are obtained for dirty spot detection. As shown in FIG. 4, the present embodiments provide a schematic diagram of block cutting for an image frame, where the window side length is k, the traversal step is s, and s≤k.

The purpose of block cutting is to preliminarily locate the dirty spot area, and limit the dirty spot judgment range to a smaller image block, so as to avoid the inaccurate judgment due to the influence of motion artifact area more than the dirty spot area when calculating the structural similarity. The parameters k and s are used for controlling the sizes and intervals of the image blocks. The fixed constraining condition is s≤k. Generally speaking, the value of the parameter k should be slightly larger than the size of the dirty spot area. If k is too small, the cut image block cannot cover the dirty spot area, and there are too many cut blocks, and the number of operations is too much, which affects the efficiency of the algorithm. If k is too large, the structural difference of the dirty spot area is too small compared to the whole image block, which will affect the accuracy of dirty spot determination.

After the current image frame and reference frame are divided into blocks, whether there are dirty spots in the current image blocks is determined in the following ways.

First, the front reference block that is determined to be of a position same as the position of each current image block from the front reference frame is used as the front reference block corresponding to the current image block, and the back reference block that is determined to be of a position same as the position of each current image block from the back reference frame is used as the back reference block corresponding to the current image block. Each current reference block, the corresponding front reference block and the back reference block can be used as a group of image blocks, and then the corresponding filtered image blocks are calculated for each group of image blocks. In the implementation, for each current image block, the current image block, the front reference block and the back reference block corresponding to the current image block are filtered by using the filtering algorithm to obtain a filtered image block(s).

Optionally, the median filtering algorithm can be used to calculate the filtered image blocks of the current image block, the front reference block and the back reference block corresponding to the current image block. The calculation process is shown in the following formula:

$${P}_{mid} ( i , j ) = {f}_{median} ( {P}_{t - ( n + 1 )} ( i , j ) , {P}_{t} ( i , j ) , {P}_{t + ( m + 1 )} ( i , j ) ) . \qquad Formula ( 1 b )$$

In the formula (1b), P_{mid} (i,j) represents the filtered image block, Pₜ₋₍ₙ₊₁₎ (i, j) represents the front reference block, Pₜ (i, j) represents the current image block, Pₜ₊₍ₘ₊₁₎ (i, j) represents the back reference block, n and m represent the number of frames spaced, (i, j) represents coordinates of pixels in an image block, and f_{median} (x, y, z) represents median of x, y, z.

In the implementation, the filtered image blocks can be obtained by the formula (1b) in the following conditions.

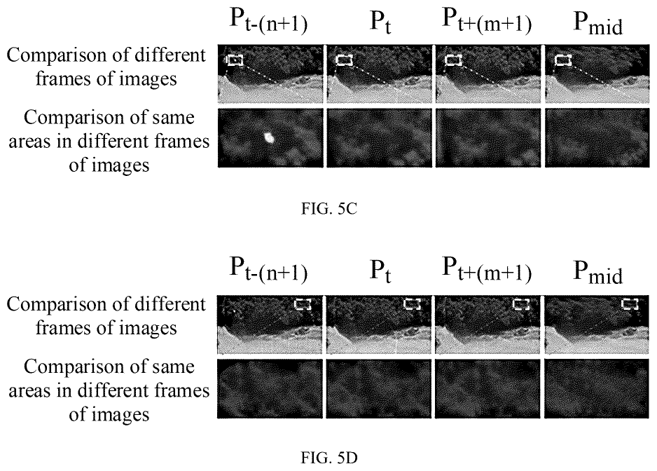

Condition a: as shown in FIG. 5A, a comparative schematic diagram of median filtering is provided in the present embodiments. The current image block Pₜ contains a dirty spot, and the front and back reference blocks Pₜ₋₍ₙ₊₁₎ and Pₜ₊₍ₘ₊₁₎ do not contain dirty spots. Because the pixel value of the dirty spot area is quite different from the value of surrounding pixel, and under normal circumstances, the pixel value of consecutive frames in the same area of the same scene picture does not change much, so the obtained filtered image block P_{mid} does not contain a dirty spot.

Condition b: as shown in FIG. 5B, a comparative schematic diagram of median filtering is provided in the present embodiments. The current image block Pₜ contains a dirty spot, and the front and back reference blocks Pₜ₋₍ₙ₊₁₎ and Pₜ₊₍ₘ₊₁₎ do not contain dirty spots, but moving objects in the front and back reference frames are exactly located at the location of the dirty spots and are close to the pixel values of the dirty spots, and the obtained filtered image block P_{mid} contains a dirty spot.

Condition c: as shown in FIG. 5C, a comparative schematic diagram of median filtering is provided in the present embodiments. The current image block Pₜ does not contain a dirty spot, and any of the front and back reference blocks Pₜ₋₍ₙ₊₁₎ and Pₜ₊₍ₘ₊₁₎ contains a dirty spot, and the filtered image block P_{mid} does not contain a dirty spot.

Condition d: as shown in FIG. 5D, a comparative schematic diagram of median filtering is provided in the present embodiments. The current image block Pₜ does not contain a dirty spot, the front and back reference blocks Pₜ₋₍ₙ₊₁₎ and Pₜ₊₍ₘ₊₁₎ do not contain dirty spots, and the filtered image block P_{mid} does not contain a dirty spot.

Secondly, the maximum similarity is determined from the similarities of the filtered image block to the front reference block and the back reference block respectively. Similarity is used to represent the correlation between pixels of image blocks at the same position in different image frames. The similarity includes structural similarity and/or average structural similarity.

In the implementation, for each group of image blocks containing the current image block Pₜ, the front reference block Pₜ₋₍ₙ₊₁₎ and the back reference block Pₜ₊₍ₘ₊₁₎, the structural similarities of the filtered image block to the front reference block and the back reference block can be calculated, respectively.

(1) Calculating the structural similarity between the filtered image block P_{mid} and the front reference block Pₜ₋₍ₙ₊₁₎, which is denoted as S1′.

(2) Calculating the structural similarity between the filtered image block P_{mid} and the back reference block Pₜ₊₍ₘ₊₁₎, which is denoted as S2′.

(3) Calculating the structural similarity between the filtered image block P_{mid} and the current image block Pₜ, which is denoted as S0′.

In the implementation, the structural similarity is calculated by the following formula:

$$SSIM ( x , y ) = \frac{( 2 \times μ ( x ) \times μ ( y ) + {c}_{1} ) ( σ ( x , y ) + {c}_{2} )}{( {μ ( x )}^{2} + {μ ( y )}^{2} + {c}_{1} ) ( {σ ( x )}^{2} + {σ ( y )}^{2} + {c}_{2} )} ; \qquad Formula ( 2 b )$$

$$μ ( x ) = \frac{1}{H \times W \times C} {\sum }_{i = 1}^{H} {\sum }_{j = 1}^{W} {\sum }_{k = 1}^{C} x ( i , j , k ) ;$$

$$μ ( y ) = \frac{1}{H \times W \times C} {\sum }_{i = 1}^{H} {\sum }_{j = 1}^{W} {\sum }_{k = 1}^{C} y ( i , j , k ) ;$$

$$σ ( x ) = \sqrt{\frac{1}{H \times W \times C} {\sum }_{i = 1}^{H} {\sum }_{j = 1}^{W} {\sum }_{k = 1}^{C} {( x ( i , j , k ) - μ ( x ) )}^{2}} ;$$

$$σ ( y ) = \sqrt{\frac{1}{H \times W \times C} {\sum }_{i = 1}^{H} {\sum }_{j = 1}^{W} {\sum }_{k = 1}^{C} {( x ( i , j , k ) - μ ( y ) )}^{2}} ;$$

$$σ ( x , y ) = \frac{1}{H \times W \times C} {\sum }_{i = 1}^{H} {\sum }_{j = 1}^{W} {\sum }_{k = 1}^{C} ( x ( i , j , k ) - μ ( x ) ) ( y ( i , j , k ) - μ ( y ) ) .$$

The SSIM(x, y) in the formula (2b) represents the structural similarity of image block x and image block y; μ (x) and μ (y) represent the average value of image block x and image block y; σ (x) and σ (y) represent the standard deviation of image block x and image block y respectively; and σ(x, y) represents the covariance of image block x and image block y; c₁=6.5025, c₂=58.5225, H, W, and C represent the height, width, and number of channels of image block x or image block y respectively (usually the image is an RGB image, and the value is 3). In the present embodiments, the height, width, and number of channels of the two image blocks for obtaining structural similarity are the same.

Finally, whether there is a dirty spot in the current image block is determined according to the comparison result of the maximum similarity and the similarity of the filtered image block to the current image block.

Optionally, if the similarity of the filtered image block to the current image block is less than the maximum similarity, it is determined that there is a dirty spot in the current image frame;
if the similarity of the filtered image block to the current image block is greater than or equal to the maximum similarity, it is determined that there is no dirty spot in the current image block.

In the implementation, there are several scenarios to determine whether there is a dirty spot according to the actual situation, as follows.

Scenario a, if the current group of image blocks is shown in FIG. 5A, because there are no dirty spots in the front and back reference blocks Pₜ₋₍ₙ₊₁₎, Pₜ₊₍ₘ₊₁₎ and the filtered image block P_{mid}, and there are dirty spots in the current image block Pₜ, it can be seen according to the formula (2) that the structural similarity between the P_{mid} and the Pₜ is lower than the structural similarity calculated between the P_{mid} and the front and back reference blocks, that is, S0′<S1′ or S0′<S2′, the judgment result is that there are dirty spots in the current image block.

Scenario b, if the current group of image blocks is shown in FIG. 5B, although there are no dirty spots in the front and back reference blocks Pₜ₋₍ₙ₊₁₎, Pₜ₊₍ₘ₊₁₎, there are dirty spots in the Pₜ. Because there is a large inter-frame motion at the location of the dirty spots, the pixel value in the dirty spot area is close to the value of the normal pixels in the Pₜ₋₍ₙ₊₁₎, so the position in the median filtered image is the pixel value of the dirty spot area, so there may be S0′≥max(S1′, S2′), there may also be S0′<max(S1′, S2′). If S0′<max(S1′, S2′), it is determined that there is a dirty spot, and it will normally enter the follow-up process for processing. If S0′≥max(S1′, S2′), it is determined that there is no dirty spot. Because there are similar pixel values in the dirty spot areas of the front and back adjacent frames, the visual sensitivity to dirty spots is much weaker during video playback, so the impact of not processing on the overall viewing effect is not great.

Scenario c, if the current group of image blocks is shown in FIG. 5C, there are dirty spots in the Pₜ₋₍ₙ₊₁₎ causing S0′>S1′, there are two possibilities: if S0′>S2′, it is directly determined that there are no dirty spots; if S0′<S2′, it is determined that there are dirty spots to be filled, but because there are no dirty spots in the Pₜ, the back reference block Pₜ₊₍ₘ₊₁₎ corresponding to S2′ with high structural similarity will be used as the filling material, and will not be affected by the dirty spots in the front reference block Pₜ₋₍ₙ₊₁₎.

Scenario d, if the image blocks of the current group are shown in FIG. 5D, there are no dirty spots in P_{mid}, Pₜ₋₍ₙ₊₁₎, Pₜ₊₍ₘ₊₁₎ and Pₜ, and S0′>S1′ and S0′>S2′ according to the formulas (1) and (2), then it is determined that there are no dirty spots.

As such, the image blocks containing dirty spots can be filtered by the determination condition S0′<max(S1′, S2′).

In some embodiments, after determining the existence of dirty spots in the current image frame/current image block through the above methods, it is necessary to further determine the specific position and shape range of the dirty spots in the image frame/image block, so that pixels of the same position and range in the front and back reference frames/reference blocks are used to fill in and repair.

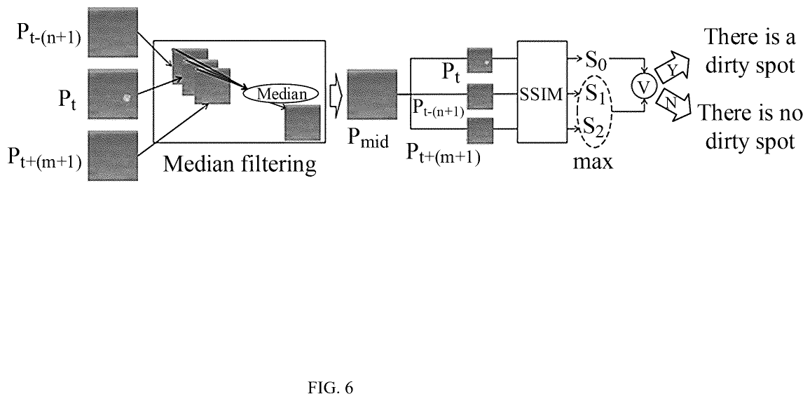

As shown in FIG. 6, the present embodiments provide a process of automatic positioning of dirty spots. The current image block containing dirty spots and the corresponding front and back reference blocks are filtered by the median filtering in the time domain to obtain the corresponding filtered image blocks. The structural similarity between the filtered image block and the current image block, the structural similarity between the filtered image block and the front reference block and the structural similarity between the filtered image block and the back reference block are calculated. Whether there are dirty spots in the current image block is determined by comparing the structural similarity between the filtered image block and the front reference block with the maximum structural similarity. The maximum structural similarity is the maximum value of the structural similarity between the filtered image block and the front reference block and the structural similarity between the filtered image block and the back reference block.

Taking the image frame as a detection unit as an example, the embodiments can also repair the image frame containing dirty spots through the following steps.

Step 1) obtaining a binary image according to the comparison result of the similarity of the filtered image frame to the current image frame and a similarity threshold, where the binary image is used for representing a mask image of the dirty spot(s) in the current image frame.

In the implementation, the current image frame Iₜ and the filtered image frame I_{mid} after median filtering are selected, and an average structural similarity (MSSIM) of the current image frame Iₜ and the filtered image frame I_{mid} is calculated, to obtain a structural similarity matrix M of each pixel in the corresponding image frame. The calculation formula of the structural similarity matrix is shown in the formula (3a), and a similarity parameter w represents a range of a local area that affects the structural similarity of the pixels at the same position in the two image frames when the average structural similarity is calculated by using the structural similarity of pixels at the same position in two image frames. That is, the range of the local area that affects the structure similarity value of the current position is controlled by w in the process of calculating the average structure similarity. The smaller the w is, the smaller the range is, the more the structural difference is reflected in the details; the larger the w is, the larger the range is, and the structural difference changes are more general.

As shown in FIG. 7, the present embodiments provide a schematic diagram of a change relationship between the similarity matrix and w. In the same group of image frames/image blocks, with the change of w, that is, the larger the w is, the larger the range of the low similarity region (the black area in the figure) in MSSIM is, and empirically, the value of w is about 0.2 times the preset window size.

$$M ( i , j ) = SSIM ( {x}_{i , j}^{w} , {y}_{i , j}^{w} ) . \qquad Formula ( 3 a )$$

In the formula (3a), M(i, j) represents the structural similarity (matrix) of different image frames, and the similarity parameter w represents the range of the local area affecting the structural similarity of pixels at the same position in two image frames when calculating the average structural similarity by using the structural similarity of pixels at the same position in two image frames; x represents one image frame, y represents another image frame, and (i, j) represents coordinates of pixels in the image; w is an odd number greater than 1;

$${x}_{i , j}^{w}$$

represents the sub-block centered on the pixel x (i, j) with the side length of w in the image frame x;

$${y}_{i , j}^{w}$$

represents the sub-block centered on pixel x (i, j) with the side length of w in the image frame y, and the value of M(i, j) is the structural similarity value of the sub-blocks corresponding to x and y.

The width and height of the structural similarity matrix M is equal to the width and height of the image frame, and each value in M is a structural similarity value of the pixel on the corresponding coordinates of the image frame, the smaller the difference between the two pixels is, the closer the similarity value is to 1; the greater the difference between the two pixels is, and the closer the similarity value is to 0. The values in M are controlled by the similarity threshold v. The pixel greater than v in M is reassigned to 0, and the pixel less than v is reassigned to 1, so as to obtain the binary image mask of dirty spots:

$$mask ( i , j ) = \{ \begin{matrix}0 , & M ( i , j ) > v \\ 1 , & M ( i , j ) \leq v\end{matrix} . \qquad Formula ( 4 a )$$

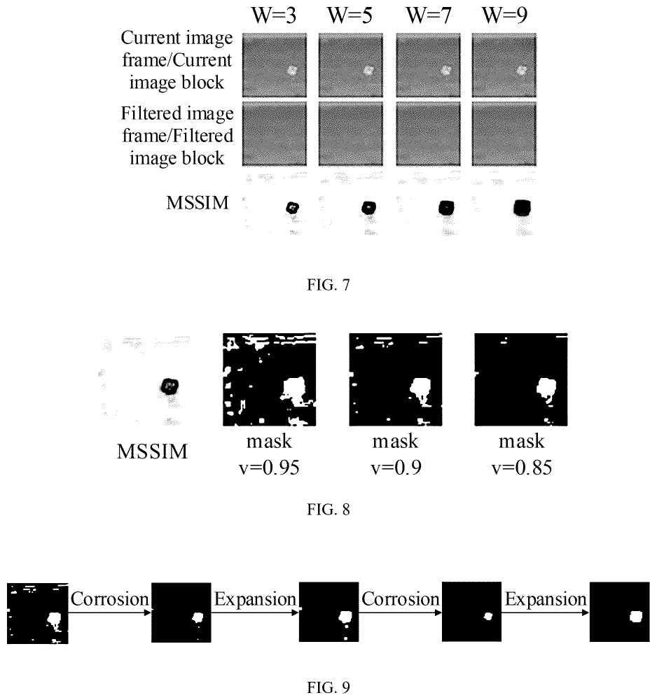

In the formula (4a), M(i, j) represents the structural similarity matrix of different image frames; v represents the similarity threshold, and is usually set between 0.85^{~}0.95; as shown in FIG. 8, the present embodiments provide a schematic diagram of the change of a binary image with the value v, the smaller the value v is, the fewer scattered error points in the mask are, but if the value v is too small, it will lead to incomplete delineation of the dirty spot area. The larger the value v is, the more complete the dirty spot area is, but more error scatters will be introduced.

In some embodiments, the following processing can be carried out after obtaining a binary image:
denoising the binary image at least once to obtain a processed binary image to repair the dirty spot in the current image frame according to the processed binary image and the reference frame corresponding to the current image frame; where the denoising includes a corrosion process and/or and expansion process.

In the implementation, multiple corrosion-expansion processes can be performed, and the specific number of corrosion-expansion processes is related to the size of dirty spot. The method and number of denoising treatments can be customized.

After obtaining the binary image, it is necessary to further carry out two consecutive corrosion-expansion processes on the binary image of the dirty spot, to remove the scattered white spot noise on the binary image as much as possible, and obtain a relatively complete large connected area, i.e., a more accurate dirty spot area range. As shown in FIG. 9, the present embodiments provide a schematic diagram of the change of the binary image in the corrosion-expansion processes.

Step 2) repairing dirty spots in the current image frame according to the binary image and the reference frame corresponding to the current image frame.

In the implementation, when performing dirty spot repair, any frame in the reference frame of the current image frame can be selected for repair, such as the front reference frame or the back reference frame can be selected to repair the dirty spot in the current image frame. In order to ensure the repair effect, the reference frame corresponding to the maximum value in the structural similarity of the filtered image frame can be selected as the reference frame for dirty spot repair.

In the implementation, the repaired image frame is represented as the following formula:

$${I}_{t}^{′} ( i , j ) = \{ \begin{matrix}{I}_{t} ( i , j ) , & mask ( i , j ) = 0 \\ {I}_{t - a} ( i , j ) , & mask ( i , j ) = 1\end{matrix} . \qquad For mula ( 5 a )$$

In the formula (5a),

$${I}_{t}^{′} ( i , j )$$

represents the repaired image frame, Iₜ(i, j) represents the current image frame, Iₜ₋ₐ(i, j) represents the reference frame corresponding to the maximum similarity, and mask(i, j) represents the binary image.

In some embodiments, matrix operations can be used to speed up processing in the process of calculating the repaired image frames, and the specific repairing steps are as follows.

Step 2a) performing inverting processing on the binary image to obtain an inverted image.

In the implementation, the inverted image mask' of the binary image mask is obtained by the following formula:

$${mask}^{′} ( i , j ) = 1 - mask ( i , j ) . \qquad Formula ( 6 a )$$

In the formula (6a), mask(i, j) represents the binary image, mask' (i, j) represents the inverted image, and (i, j) represents coordinates of pixels.

Step 2b) determining a first image matrix according to a product of the reference frame corresponding to the current image frame and the binary image, and determining a second image matrix according to a product of the current image frame and the inverted image.

Optionally, the reference frame corresponding to the current image frame includes a reference frame corresponding to the maximum similarity of the similarity of the filtered image frame to the front reference frame corresponding to the current image frame and the similarity of the filtered image frame to the back reference frame corresponding to the current image frame.

Step 2c) determining the image frame after repairing the dirty spots in the current image frame according to a sum of the first image matrix and the second image matrix.

In the implementation, the repaired image frame is obtained by the following formula:

$${I}_{t}^{′} ( i , j ) = {I}_{t - a} ( i , j ) * mask ( i , j ) + {I}_{t} ( i , j ) * {mask}^{′} ( i , j ) . \qquad Formula ( 7 a )$$

In the formula (7a),

$${I}_{t}^{′} ( i , j )$$

represents the repaired image frame, Iₜ(i, j) represents the current image frame, Iₜ₋ₐ(i, j) represents the reference frame corresponding to the maximum similarity, mask(i, j) represents the binary image, and mask'(i, j) represents the inverted image.

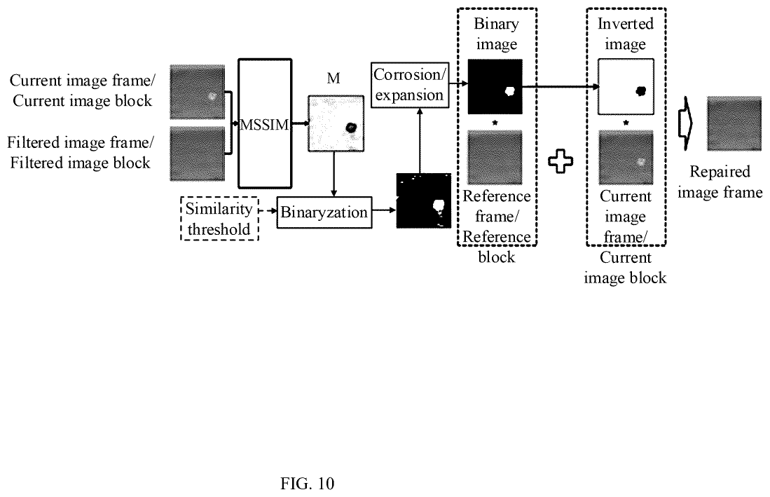

As shown in FIG. 10, the present embodiments further provide a flow chart of a process of repairing a dirty spot. When the image frame is used as a basic unit for detection, firstly an average structural similarity of the filtered image frame to the current image frame is calculated, and the binary image is obtained by comparing the average structural similarity with a similarity threshold; then after corrosion-expansion process is performed on the binary image, an inverted image of the processed binary image is calculated, and finally a first image matrix is determined according to a product of the reference frame corresponding to the current image frame and the binary image, and a second image matrix is determined according to a product of the current image frame and the inverted image; the image frame after repairing the dirty spots in the current image frame is determined according to a sum of the first image matrix and the second image matrix. When an image block is used as a basic unit for detection, an average structural similarity between a filtered image block and a current image block is calculated firstly, and a binary image block is obtained by comparing the average structural similarity with a similarity threshold; then after corrosion-expansion is performed on the binary image, an inversed image of the processed binary image block is calculated, and finally a first image matrix is determined according to a product of the reference block corresponding to the current image block and the binary image block, and a second image matrix is determined according to a product of the current image block and the inverted image of the binary image block, and an image frame/image block after repairing dirty spots in the current image block is determined according to a sum of the first image matrix and the second image matrix.

In some embodiments, taking an image block as a detection unit as an example, if it is determined that there is (are) dirty spot(s) in the current image block, the embodiments may also repair the image block containing a dirty spot(s) through the following steps.

Step 1) according to the comparison result of the similarity of the filtered image block to the current image block and a similarity threshold, obtaining a binary image block, where the binary image block is used for representing a mask image of the dirty spot in the current image block.

In the implementation, the current image block Pₜ and the filtered image frame P_{mid} after median filtering are selected, an average structural similarity (MSSIM) of the two is calculated, and a structural similarity matrix M of each pixel in the corresponding image block is obtained. The calculation formula of the structural similarity matrix is shown in the formula (3b), and the similarity parameter w represents the range of the local area that affects the structural similarity of the pixels at the same position in the two image blocks when calculating the average structural similarity by using the structural similarity of pixels at the same position in two image blocks, that is, the range of the local area that affects the structure similarity value of the current position is controlled by w in the process of calculating the average structure similarity. The smaller the w is, the smaller the range is, the more the structural difference is reflected in the details; the larger the w is, the larger the range is, and the structural difference changes are more general.

$$M ( i , j ) = SSIM ( {x}_{i , j}^{w} , {y}_{i , j}^{w} ) , \qquad formula ( 3 b ) .$$

In the formula (3a), M(i, j) represents the structural similarity (matrix) of different image blocks, and the similarity parameter w represents the range of local area that affects the structural similarity of pixels at the same position in the two image blocks when calculating the average structural similarity by using the structural similarity of pixels at the same position in two image blocks; x represents one image block, y represents another image block, and (i, j) represents coordinates of pixels in the image block; w is an odd number greater than 1,

$${x}_{i , j}^{w}$$

represents the sub-block centered on pixel x (i, j) with the side length of w in the image block x;

$${y}_{i , j}^{w}$$

represents the sub-block centered on pixel x (i, j) with the side length of w in the image block y; and the value of M(i, j) is the structural similarity value of the corresponding sub-blocks of x and y.

The width and height of the structural similarity matrix M are equal to the width and height of the image block, and each value in M is the structural similarity value of the pixels on the corresponding coordinates of the image block. The smaller the difference between the two pixels is, the closer the similarity value is to 1, the greater the difference between the two pixels is, the closer the similarity value is to 0. The similarity value is controlled by the similarity threshold v. The pixel greater than v in M is reassigned to 0, and the pixel less than v is reassigned to 1, so as to obtain the binary image mask of dirty spots.

$$mask ( i , j ) = \{ \begin{matrix}0 , & M ( i , j ) > v \\ 1 , & M ( i , j ) \leq v\end{matrix} . \qquad Formula ( 4 b )$$

In the formula (4b), M(i, j) represents the structural similarity matrix of different image blocks; v represents the similarity threshold, and is usually set between 0.85^{~}0.95. The smaller the value v is, the fewer scattered error points in the mask are, but if the value v is too small, it will lead to incomplete delineation of the dirty spot area. The larger the value v is, the more complete the dirty spot area is, but it will introduce more wrong scatters.

In some embodiments, the following processing can be carried out after obtaining the binary image:
denoising the binary image at least once to obtain the processed binary image to repair the dirty spots in the current image block according to the processed binary image and the reference frame corresponding to the current image block. The denoising includes a corrosion process and/or an expansion process.

In the implementation, multiple corrosion-expansion processes can be performed, and the specific number of corrosion-expansion processes is related to the size of dirty spots, and the method and number of denoising process can be customized.

After obtaining the binary image, it is necessary to further carry out two consecutive corrosion-expansion processes on the binary image of dirty spots, so as to remove the scattered white spot noise on the binary image as much as possible, and obtain a relatively complete large connected area, that is, a more accurate range of a dirty spot area.

Step 2) repairing dirty spots in the current image block according to the binary image block and the reference block corresponding to the current image block to obtain the repaired image block, where the reference block is determined according to the image block that is at the position same as the position of the current image block in the reference frame corresponding to the current image frame.

In the implementation, when carrying out dirty point repair, any one of the reference blocks of the current image block can be selected for repair, such as the front reference block or the back reference block can be selected to repair the dirty points in the current image block. In order to ensure the repair effect, the reference block corresponding to the maximum value of the structural similarity of the filtered image block can be selected as the reference block for dirty spot repair.

In the implementation, the repaired image block is represented as the following formula:

$${P}_{t}^{′} ( i , j ) = \{ \begin{matrix}{P}_{t} ( i , j ) , & mask ( i , j ) = 0 \\ {P}_{t - a} ( i , j ) & mask ( i , j ) = 1\end{matrix} . \qquad Formula ( 5 b )$$

In the formula (5b),

$${P}_{t}^{′} ( i , j )$$

represents the repaired image block, Pₜ (i, j) represents the current image block, Pₜ₋ₐ(i, j) represents the reference block corresponding to the maximum similarity, and mask(i, j) represents the binary image.

In some embodiments, matrix operations can be used to speed up the process of calculating the repaired image block, and the specific repairing steps are as follows.

Step 2a) performing inverting processing on the binary image block to obtain an inverted image block.

In the implementation, the inverted image mask' of the binary image mask is obtained by the following formula:

$${mask}^{′} ( i , j ) = 1 - mask ( i , j ) . \qquad Formula ( 6 b )$$

In the formula (6b), mask(i, j) represents a binary image block, mask'(i, j) represents an inverted image block, and (i, j) represents coordinates of pixels.

Step 2b) determining a first image block matrix according to a product of the reference block corresponding to the current image block and the binary image block, and determining a second image block matrix according to a product of the current image block and the inverted image block.

Optionally, the reference block corresponding to the current image block includes a reference block corresponding to the maximum similarity of the similarity of the filtered image block to the front reference block corresponding to the current image block, and the similarity of the filtered image block to the back reference block corresponding to the current image block.

Step 2c) determining the image block after repairing the dirty spots in the current image block according to a sum of the first image block matrix and the second image block matrix.

In the implementation, the repaired image block is obtained by the following formula:

$${P}_{t}^{′} ( i , j ) = {P}_{t - a} ( i , j ) * mask ( i , j ) + {P}_{t} ( i , j ) * {mask}^{′} ( i , j ) . \qquad Formula ( 7 b )$$

In the formula (7b),

$${P}_{t}^{′} ( i , j )$$

represents the repaired image block, Pₜ(i, j) represents the current image block, Pₜ₋ₐ(i, j) represents the reference block corresponding to the maximum similarity, mask(i, j) represents the binary image block, and mask'(i, j) represents the inverted image block.

Step 3) replacing the current image block with the repaired image block.

In the implementation, the repaired image block can be attached back to the current image block according to the corresponding position. Repeating the above steps for dirty spot detection and repair of image blocks until all image blocks with dirty spots have been repaired. Finally, the next frame in the image sequence is extracted sequentially, and the above steps are repeated until the dirty spot repair of the entire video is completed.

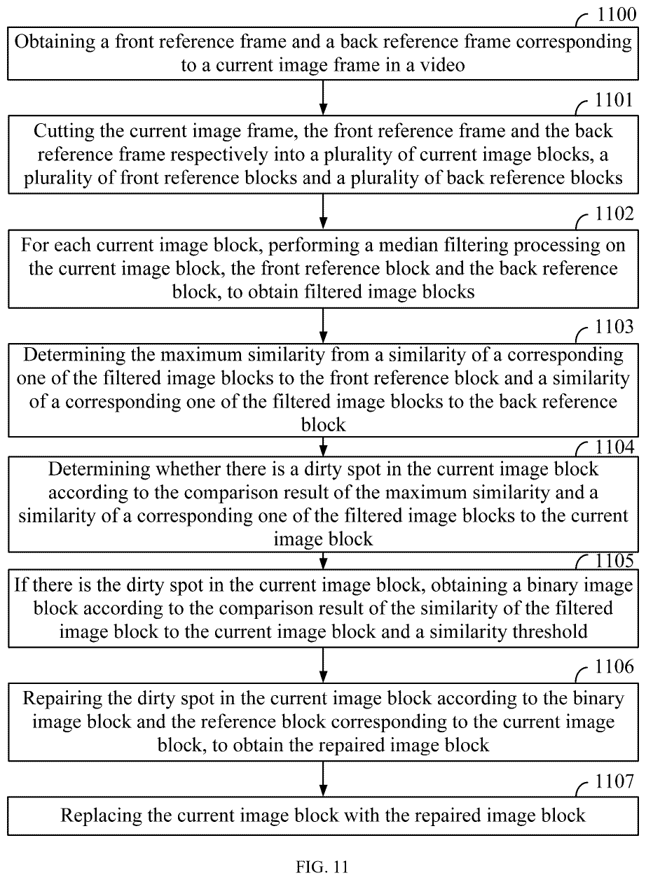

As shown in FIG. 11, the present embodiments provide a process for detecting and repairing dirty spots in a video, and the specific implementation steps of the process are as follows:
Step 1100, obtaining a front reference frame and a back reference frame corresponding to a current image frame in the video;
Step 1101, cutting the current image frame, the front reference frame and the back reference frame respectively into a plurality of current image blocks, a plurality of front reference blocks and a plurality of back reference blocks;
Step 1102, for each current image block, carrying out median filtering processing on the current image block, the front reference block and the back reference block, to obtain filtered image blocks;
Step 1103, determining a maximum similarity from a similarity of a corresponding one of the filtered image blocks to the front reference block and a similarity of a corresponding one of the filtered image blocks to the back reference block;
Step 1104, determining whether there is a dirty spot in the current image block according to the comparison result of the maximum similarity and a similarity of a corresponding one of the filtered image blocks to the current image block;
Step 1105, if there is the dirty spot in the current image block, obtaining a binary image block according to the comparison result of the similarity of the filtered image block to the current image block and the similarity threshold;
Step 1106, repairing the dirty spot in the current image block according to the binary image block and the reference block corresponding to the current image block, to obtain the repaired image block;
Step 1107, replacing the current image block with the repaired image block.

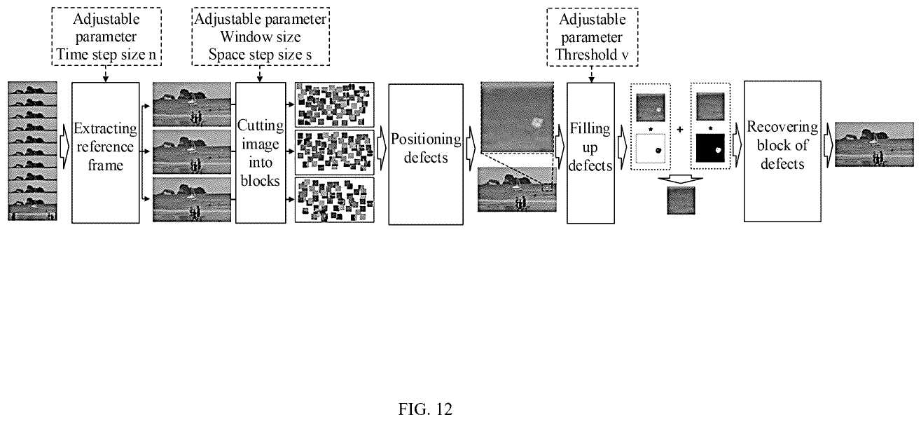

As shown in FIG. 12, the present embodiments further provide a flow chart of a detection and repair algorithm. Assuming that the video resolution to be processed is H×W, H is the number of rows of pixels, W is the number of columns of pixels, and the image frame at the current moment is Iₜ, when a video is decoded into a continuous sequence of image frames, for the image frame of the t time node, the required reference frame is extracted according to the hyper-parameters “interval n” and “interval m”, and the extracted current image frame and reference frame are divided into blocks according to the hyper-parameters “preset window size” and “preset step size”. The algorithm processes each group of image blocks in turn. Each group of image blocks includes an image block of the current image frame and a reference block at the same position as the image block in the reference frame. Firstly, it is necessary to locate the defects of the current group of image blocks, that is, according to the preset determination conditions, whether the current image blocks contain dirty spots is determined by calculating and comparing the structural similarity, so as to realize the automatic detection of dirty spots. Then, the precise area of the dirty spots is determined according to calculated similarity matrix M, and the hyper-parameter “similarity threshold”. Finally, the pixel values at the same position of the reference frame are extracted to fill in and repair the content that is covered by the dirty spot.

In the implementation, a three-frame image sequence with an interval of n in the video can be extracted, it can be cut into blocks according to the parameters of the preset window size k and the preset step size of s. The median filtering is performed on pixels corresponding to each group of three image blocks. The structural similarity of the filtered image blocks to the three image blocks is calculated in turn. The formula S0<max(S1, S2) is used to determine whether there are dirty spots in the current group of image blocks. For the image block groups with dirty spots, the average structural similarity of the current image block to the filtered image block is calculated. The specific area of the dirty spots in the picture is obtained according to the similarity threshold v, and is filled and repaired with the adjacent image block of higher structural similarity, so as to realize the detection and repair of the dirty spot in the video picture.

Based on the same inventive conception, the embodiments of the present disclosure further provide a device for detecting a dirty spot in a video, because the device is the device in the method in the embodiments of the present disclosure, and the principle of the device solving the problem is similar to the method, the implementation of the device can refer to the implementation of the method, and the repetition is not repeated.

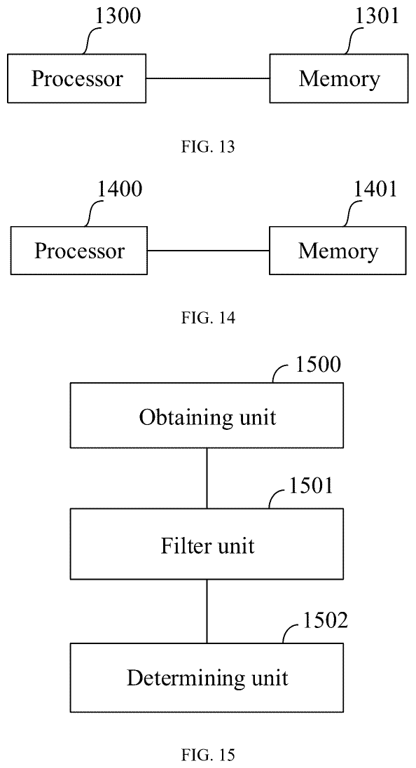

As shown in FIG. 13, the device includes a processor 1300 and a memory 1301. The memory 1301 is configured to store executable programs of the processor 1300, and the processor 1300 is configured to read the programs in the memory 1301 and perform the following steps:

in response to a user's input operation of at least one of a time parameter, a similarity parameter, a similarity threshold, a preset window size, or a preset step size, detecting the dirty spots of the image frame in the video according to any of the above methods for detecting the dirty spot in the video, and the parameters corresponding to the input operation;
the time parameter represents the number of frames between the current image frame and the reference frame of the current image frame; the similarity parameter represents the range of the local area that affects the structural similarity of pixels at the same position in two image frames when calculating the average structural similarity by using the structural similarity of pixels at the same position in two image frames.

In some embodiments, the time parameter includes an interval n and an interval m, n represents the number of frames between the front reference frame and the current image frame, m represents the number of frames between the back reference frame and the current image frame, and n is an integer greater than or equal to 0 and m is an integer greater than or equal to 0.

In some embodiments, the similarity parameter includes w, representing the range of a local area that affects the structural similarity of pixels at the same position in two image frames when calculating the average structural similarity.

In some embodiments, the similarity threshold includes v being used to obtain binary image blocks according to the comparison result of the similarity of the filtered image block to the current image block and the similarity threshold.

In some embodiments, the preset window size and the preset step size are used to traverse the current image frame, the front reference frame and the back reference frame respectively according to the preset step size using the preset window, and cut out a plurality of current image blocks of the preset window size, a plurality of front reference blocks of the preset window size and a plurality of back reference blocks of the preset window size. The preset step size includes a horizontal step size in the horizontal direction and a vertical step size in the vertical direction, the horizontal step size is less than or equal to the width of the preset window, and the vertical step size is less than or equal to the height of the preset window.

In the implementation, the method for detecting a dirty spot in a video can be designed as a video processing plug-in and applied to the device, and is used as a toolkit for video editing and processing software such as da Vinci editing software, Adobe Premiere, etc., and is used when editing video files. The plug-in tool can expose multiple parameters such as an interval n, an interval m, a preset window size, a preset step size, a similarity parameter, a similarity threshold for users to freely set to match video files of different resolutions, different qualities, and different scenes.

The method for detecting a dirty spot in a video provided in the present embodiments can flexibly adjust parameters, and control the intermediate process, and is suitable for solving dirty pixel videos with different problems. It does not rely on deep learning application frameworks, can be flexibly deployed and used on different platforms, and does not rely on AI computing resources such as GPUs and NPUs, and has fewer restrictions on hardware devices. In addition, the method of local detection of dirty spot areas based on the structural similarity of adjacent image frames improves the detection accuracy and reduces the probability of introducing artifacts compared with global detection. By calculating the average structural similarity, the contours and shapes of dirty spots are further accurately located, and the area are repaired and filled with reference to adjacent frame pixels. The method for detecting a dirty spot in a video provided in the present disclosure can also be combined with the deep learning method described in the background technology to provide more hyper-parameters for the deep learning method and expand the applicability of the deep learning scheme.

Based on the same inventive conception, the embodiments of the present disclosure further provide an electronic device, and since the electronic device is an electronic device in the method in the embodiments of the present disclosure, and the principle of solving the problem of the electronic device is similar to the method, the implementation of the electronic device can be referred to the implementation of the method, and the repetition is not repeated.

As shown in FIG. 14, the electronic device includes a processor 1400 and a memory 1401. The memory 1401 is configured to store executable programs of the processor 1400, and the processor 1400 is configured to read the programs in the memory 1401 and perform the following steps:
obtaining a reference frame corresponding to a current image frame in the video, where the reference frame includes a front reference frame and a back reference frame, the front reference frame is an image frame before the current image frame in the video, and the back reference frame is an image frame after the current image frame in the video;
filtering the current image frame, the front reference frame corresponding to the current image frame and the back reference frame corresponding to the current image frame to obtain filtered image frames; and
determining whether there is a dirty spot in the current image frame according to a similarity of the filtered image frame to the current image frame, a similarity of the filtered image frame to the front reference frame corresponding to the current image frame and a similarity of the filtered image frame to the back reference frame corresponding to the current image frame, respectively.

As an optional embodiment, the front reference frame and the current image frame are spaced by n image frames. n is determined based on the number of frames in which dirty spots occur in successive image frames, and n is an integer greater than or equal to 0; and/or, the back reference frame and the current image frame are spaced by m image frames. m is determined based on the number of frames in which dirty spots occur in successive image frames, and m is an integer greater than or equal to 0.

As an optional embodiment, the processor 1400 is specifically configured to execute:
determining a maximum similarity from the similarity of the filtered image frame to the front reference frame and the similarity of the filtered image frame to the back reference frame; and
determining whether there is the dirty spot in the current image frame according to a comparison result of the maximum similarity and the similarity of the filtered image frame to the current image frame.

As an optional embodiment, the processor 1400 is specifically configured to execute:
if the similarity of the filtered image frame to the current image frame is less than the maximum similarity, determining there is the dirty spot in the current image frame; or
If the similarity of the filtered image frame to the current image frame is greater than or equal to the maximum similarity, determining there is no dirty spot in the current image frame.

As an optional embodiment, the processor 1400 is specifically configured to execute:
if the front reference frame includes a plurality of continuous image frames before the current image frame in the video, determining the maximum similarity from the similarity of the filtered image frame to each front reference frame and the similarity of the filtered image frame to the back reference frame respectively; or
if the back reference frame includes a plurality of continuous image frames after the current image frame in the video, determining the maximum similarity from the similarity of the filtered image frame to the front reference frame and the similarity of the filtered image frame to each back reference frame respectively; or
if the front reference frame includes a plurality of continuous image frames before the current image frame in the video, and the back reference frame includes a plurality of continuous image frames after the current image frame in the video, the maximum similarity is determined from the similarity of the filtered image frame to each front reference frame and the similarity of the filtered image frame to each back reference frame.

As an optional embodiment, if it is determined that there is a dirty spot in the current image frame, the processor 1400 is specifically configured to execute:
obtaining a binary image according to a comparison result of the similarity of the filtered image frame to the current image frame and a similarity threshold, where the binary image is used for representing the mask image of the dirty spot in the current image frame; and
repairing the dirty spot in the current image frame according to the binary image and the reference frame corresponding to the current image frame.

As an optional embodiment, the processor 1400 is specifically configured to execute:
inverting the binary image to obtain an inverted image;
determining a first image matrix according to a product of the reference frame corresponding to the current image frame and the binary image, and determining a second image matrix according to a product of the current image frame and the inverted image; and
determining an image frame after repairing the dirty spot in the current image frame according to a sum of the first image matrix and the second image matrix.

As an optional embodiment, the reference frame corresponding to the current image frame includes a reference frame corresponding to a maximum similarity of the similarity of the filtered image frame to the front reference frame corresponding to the current image frame and the similarity of the filtered image frame to the back reference frame corresponding to the current image frame.

As an optional embodiment, after obtaining the binary image according to the comparison result of the similarity of the filtered image frame to the current image frame and the similarity threshold, the processor 1400 is specifically configured to execute:
denoising the binary image at least once to obtain a processed binary image to repair the dirty spot in the current image frame according to the processed binary image and the reference frame corresponding to the current image frame; where the denoising includes a corrosion process and/or an expansion process.

As an optional embodiment, before filtering the current image frame, the front reference frame corresponding to the current image frame and the back reference frame corresponding to the current image frame to obtain the filtered image frames, the processor 1400 is specifically configured to execute:
cutting the current image frame, the front reference frame and the back reference frame respectively into a plurality of current image blocks, a plurality of front reference blocks and a plurality of back reference blocks.

The processor 1400 is specifically configured to execute:
for each current image block, filtering the current image block, the front reference block corresponding to the current image block and the back reference block corresponding to the current image block by using the filtering algorithm to obtain the filtered image block; and
determining whether there is the dirty spot in the current image block according to the similarity of the filtered image block to the current image block, the similarity of the filtered image block to the front reference block and the similarity of the filtered image block to the back reference block.

As an optional embodiment, the processor 1400 is specifically configured to execute:
determining the maximum similarity from the similarity of the filtered image block to the front reference block and the similarity of the filtered image block to the back reference block; and
determining whether there is the dirty spot in the current image block according to the comparison result of the maximum similarity and the similarity of the filtered image block to the current image block.

As an optional embodiment, two current image blocks closest to each other in a preset direction partially overlap. Two front reference blocks closest to each other in the preset direction partially overlap. Two back reference blocks closest to each other in the preset direction partially overlap. The preset direction includes a horizontal axis direction or a vertical axis direction.

As an optional embodiment, the processor 1400 is specifically configured to execute:
traversing the current image frame, the front reference frame and the back reference frame respectively by using a preset window according to a preset step size, and cutting out the plurality of current image blocks of a size same as a size of the preset window, the plurality of front reference blocks of a size same as the size of the preset window and the plurality of back reference blocks of a size same as the size of the preset window;
where the preset step size includes a horizontal step size in a horizontal direction and a vertical step size in a vertical direction, the horizontal step size is less than or equal to a width of the preset window, and the vertical step size is less than or equal to a height of the preset window.

As an optional embodiment, if it is determined that there is the dirty spot in the current image block, the processor 1400 is specifically configured to execute:
obtaining a binary image block according to a comparison result of the similarity of the filtered image block to the current image block and a similarity threshold, where the binary image block is used for representing a mask image of the dirty spot in the current image block;
repairing the dirty spot in the current image block according to the binary image block and a reference block corresponding to the current image block to obtain a repaired image block, where the reference block is determined according to an image block of a position same as a position of the current image block in the reference frame corresponding to the current image frame; and
replacing the current image block with the repaired image block.

As an optional embodiment, the processor 1400 is specifically configured to execute:
filtering the current image frame, the front reference frame corresponding to the current image frame and the back reference frame corresponding to the current image frame by using a filtering algorithm to obtain the filtered image frames;
where the filtering algorithm includes a time median filtering algorithm, and the time median filtering algorithm is used for obtaining a median value of pixel values at the same position in a plurality frames of images; or
the filtering algorithm includes a time mode filtering algorithm, and the time mode filtering algorithm is configured for obtaining same pixel values of a largest quantity from pixel values in the same position in a plurality frames of images.

As an optional embodiment, the similarity is used for representing a correlation between pixels of different image frames, or a correlation between pixels of image blocks of a same position in different image frames. The similarity includes a structural similarity and/or an average structural similarity.

Based on the same inventive conception, the embodiments of the present disclosure further provide an apparatus for detecting dirty spots in video, and because the apparatus is an apparatus in the method in the embodiments of the present disclosure, and the principle of solving the problem of the device is similar to that of the method, the implementation of the apparatus can refer to the implementation of the method, and the repetition is not repeated.

As shown in FIG. 15, the apparatus includes:
an obtaining unit 1500 configured to obtain a reference frame corresponding to a current image frame in the video, where the reference frame includes a front reference frame and a back reference frame, the front reference frame is an image frame before the current image frame in the video, and the back reference frame is an image frame after the current image frame in the video;
a filter unit 1501 configured to filter the current image frame, the front reference frame corresponding to the current image frame and the back reference frame corresponding to the current image frame to obtain filtered image frames; and
a determining unit 1502 configured to determine whether there is the dirty spot in the current image frame according to a similarity of the filtered image frame to the current image frame, a similarity of the filtered image frame to the front reference frame corresponding to the current image frame and a similarity of the filtered image frame to the back reference frame corresponding to the current image frame.

As an optional embodiment, the front reference frame and the current image frame are spaced by n image frames, n is determined based on the number of frames in which dirty spots occur in successive image frames, and n is an integer greater than or equal to 0; and/or, the back reference frame and the current image frame are spaced m image frames, m is determined based on the number of frames in which dirty spots occur in successive image frames, and m is an integer greater than or equal to 0.

As an optional embodiment, the determining unit 1502 is specifically configured to:
determine the maximum similarity from the similarity of the filtered image frame to the front reference frame and the similarity of the filtered image frame to the back reference frame; and
determine whether there is the dirty spot in the current image frame according to the comparison result of the maximum similarity and the similarity of the filtered image frame to the current image frame.

As an optional embodiment, the determining unit 1502 is specifically configured to:
if the similarity of the filtered image frame to the current image frame is less than the maximum similarity, determine there is a dirty spot in the current image frame; or
If the similarity of the filtered image frame to the current image frame is greater than or equal to the maximum similarity, determine there is no dirty spot in the current image frame.

As an optional embodiment, if the front reference frame is a plurality of continuous image frames before the current image frame in the video, determining the maximum similarity from the similarity of the filtered image frame to each front reference frame and the similarity of the filtered image frame to the back reference frame respectively; or
if the back reference frame is a plurality of continuous image frames after the current image frame in the video, determining the maximum similarity from the similarity of the filtered image frame to the front reference frame and the similarity of the filtered image frame to each back reference frame; or
if the front reference frame is a plurality of continuous image frames before the current image frame in the video, and the back reference frame is a plurality of continuous image frames after the current image frame in the video, determining the maximum similarity from the similarity of the filtered image frame to each front reference frame and the similarity of the filtered image frame to each back reference frame.

As an optional embodiment, the device further includes a repair unit specifically configured to: if it is determined that there is the dirty spot in the current image frame,
according to the comparison results of the similarity of the filtered image frame to the current image frame and similarity threshold, obtaining a binary image, the binary image is used for characterizing the mask image of the dirty spot in the current image frame;
repairing the dirty spot in the current image frame according to the binary image and the reference frame corresponding to the current image frame.

As an optional embodiment, the repairing unit is specifically configured to:
invert the binary image to obtain an inverted image;
determine a first image matrix according to the product of the reference frame corresponding to the current image frame and the binary image, and determine a second image matrix according to the product of the current image frame and the inverted image;
determine the image frame after repairing the dirty spots in the current image frame according to the sum of the first image matrix and the second image matrix.

As an optional embodiment, the reference frame corresponding to the current image frame includes a reference frame corresponding to the maximum similarity in the similarity of the filtered image frame to the front reference frame corresponding to the current image frame and the similarity of the filtered image frame to the back reference frame corresponding to the current image frame.

As an optional embodiment, after obtaining a binary image according to the comparison result of the similarity of the filtered image frame to the current image frame and the similarity threshold, the repair unit is further specifically configured to:
denoising the binary image at least once to obtain the processed binary image for repairing the dirty spot in the current image frame according to the processed binary image and the reference frame corresponding to the current image frame; the denoising includes corrosion and/or expansion process.

As an optional embodiment, the device further includes a block unit specifically configured to: before obtaining the filtered image frame by filtering the current image frame, the front reference frame corresponding to the current image frame and the back reference frame corresponding to the current image frame:
cutting the current image frame, the front reference frame and the back reference frame respectively into a plurality of current image blocks, a plurality of front reference blocks and a plurality of back reference blocks;
for each current image block, filtering the current image blocks, the front reference blocks corresponding to the current image blocks and the back reference blocks corresponding to the current image blocks by using the filtering algorithm, to obtain the filtered image blocks;
determining whether there are the dirty spots in the current image blocks according to the similarity of the filtered image blocks to the current image blocks, the similarity of the filtered image blocks to the front reference blocks and the similarity of the filtered image blocks to the back reference blocks.

As an optional embodiment, the judgment unit 1502 is specifically configured to:
determine the maximum similarity from the similarity of the filtered image blocks to the front reference blocks and the similarity of the filtered image blocks to the back reference blocks;
determine whether there are the dirty spots in the current image blocks according to the comparison results of the maximum similarity and the similarity of the filtered image blocks to the current image blocks.

As an optional embodiment, two current image blocks closest to each other in the preset direction partially overlap, two front reference blocks closest to each other in the preset direction partially, and two back reference blocks closest to each other in the preset direction partially overlap. The preset direction includes a horizontal axis direction or a vertical axis direction.

As an optional embodiment, the block unit is specifically configured to:
traverse the current image frame, the front reference frame and the back reference frame respectively by using the preset window according to the preset step size, and cut out a plurality of current image blocks of the size same as the size of the preset window, a plurality of front reference blocks of the size the size of the preset window and a plurality of back reference blocks of the size same as the size of the preset window;
the preset step size includes a horizontal step size in the horizontal direction and a vertical step size in the vertical direction, the horizontal step size is less than or equal to the width of the preset window, and the vertical step size is less than or equal to the height of the preset window.

As an optional embodiment, if it is determined that there are the dirty spots in the current image blocks, the repair unit is further specifically configured to:
according to the comparison results of the similarity of the filtered image blocks to the current image blocks and similarity threshold, obtain a binary image block, the binary image block is used for characterizing the mask image of the dirty spots in the current image blocks;
repairing the dirty spots in the current image blocks according to the binary image block and the reference blocks corresponding to the current image blocks to obtain the repaired image blocks, the reference blocks are determined according to the image blocks of the position same as the position of the current image blocks in the reference frame corresponding to the current image frame;
replace the current image blocks with the repaired image blocks.

As an optional embodiment, the filter unit 1501 is specifically configured to:
filter the current image frame, the front reference frame corresponding to the current image frame and the back reference frame corresponding to the current image frame by using a filtering algorithm to obtain filtered image frames;
the filtering algorithm includes a time median filtering algorithm, and the time median filtering algorithm is used for obtaining the median value of the pixel values at the same position in multiple frames of images; or
the filtering algorithm includes a time mode filtering algorithm, and the time mode filtering algorithm is used for obtaining the same pixel values of the largest quantity in pixels of the same position in multiple frames of images.

As an optional embodiment, the similarity is used for characterizing the correlation between pixels of different image frames, or the correlation between pixels of image blocks of the same position in different image frames. The similarity includes structural similarity and/or average structural similarity.

Based on the same inventive conception, the embodiment of the present disclosure provides a computer storage medium, which includes: a computer program code, and when the computer program code is run on a computer, the computer performs a video dirty spot detection method as described above. Because the principle of solving the problem of the above-mentioned computer storage medium is similar to the video dirty spot detection method, the implementation of the above-mentioned computer storage medium can refer to the implementation of the method, and the repetition will not be repeated.

In the specific implementation process, the computer storage medium may include: Universal Serial Bus Flash Drive (USB), mobile hard disk, Read-Only Memory (ROM), Random Access Memory (RAM), magnetic disk or optical disc and other storage media that can store program code.

Based on the same inventive conception, the disclosed embodiment further provides a computer program product, which includes: computer program code, when the computer program code is run on a computer, the computer performs a video dirty spot detection method as described above. Because the principle of solving the problem of the above-mentioned computer program product is similar to the video dirty spot detection method, the implementation of the above-mentioned computer program product can be referred to the implementation of the method, and the repetition will not be repeated.

A computer program product may be in any combination of one or more readable media. Readable media can be either readable signal media or readable storage media. Readable storage media may be, for example, but not limited to, electrical, magnetic, optical, electromagnetic, infrared, or semiconductor systems, devices, or components, or any combination thereof. More specific examples (non-exhaustive list) of readable storage media include: electrical connections with one or more wires, portable disks, hard disks, Random Access Memory (RAM), Read-Only Memory (ROM), Erasable Programmable Read-Only Memory (EPROM or flash), optical fibers, portable Compact Disk Read-Only Memory (CD-ROM), optical storage devices, magnetic storage devices, or any suitable combination of the above.

Those skilled in the art should understand that embodiments of the present disclosure may be provided as a process, system, or computer program product. Therefore, the present disclosure may take the form of a complete hardware embodiment, a complete software embodiment, or a combination of software and hardware embodiments. Moreover, the present disclosure may take the form of a computer program product implemented on one or more computer-available storage media (including, but not limited to, disk memory and optical memory, etc.) containing computer-usable program code.

The present disclosure is described with reference to a flow diagram and/or block diagram of a method, apparatus (system), and computer program product according to the embodiments of the present disclosure. It should be understood that each process and/or box in the flowchart and/or block diagram, as well as the combination of the process and/or box in the flowchart and/or block diagram, can be implemented by computer program instructions. These computer program instructions may be provided to the processor of a general-purpose computer, a specialized computer, an embedded processing machine, or other programmable data processing device to produce a machine such that instructions executed by the processor of the computer or other programmable data processing device produce a device used to implement the functions specified in one or more processes and/or block diagrams, one or more boxes.

These computer program instructions may also be stored in computer-readable memory capable of directing a computer or other programmable data-processing device to behave in a particular manner, so that the instructions stored in the computer's readable memory produce a manufactured product that includes a directive device that implements the functions specified in a flowchart process or processes and/or block diagram boxes or boxes.

These computer program instructions may also be loaded onto a computer or other programmable data processing device such that a series of operational steps are performed on the computer or other programmable device to produce computer-implemented processing, so that the instructions executed on the computer or other programmable device provide steps for implementing the function specified in a flowchart process or processes and/or block diagram boxes or boxes.

Obviously, a person skilled in the art may make various alterations and variations to the present disclosure without departing from the spirit and scope of the present disclosure. Thus, if these modifications and variants of the present disclosure fall within the scope of the claims of the present disclosure and its equivalents, the present disclosure is also intended to include such modifications and variants.

1.-19. (canceled)

20. A method for detecting a dirty spot in a video, comprising:
obtaining a reference frame corresponding to a current image frame in the video, wherein the reference frame comprises a front reference frame and a back reference frame, the front reference frame is an image frame before the current image frame in the video, and the back reference frame is an image frame after the current image frame in the video;
filtering the current image frame, the front reference frame corresponding to the current image frame and the back reference frame corresponding to the current image frame to obtain filtered image frames; and
determining whether there is the dirty spot in the current image frame according to a similarity of a corresponding one of the filtered image frames to the current image frame, a similarity of a corresponding one of the filtered image frames to the front reference frame corresponding to the current image frame and a similarity of a corresponding one of the filtered image frames to the back reference frame corresponding to the current image frame.

21. The method according to claim 20, wherein
the front reference frame and the current image frame are spaced by n image frames, wherein n is determined based on a quantity of frames in which dirty spots occur in successive image frames, and n is an integer greater than or equal to 0; and/or,
the back reference frame and the current image frame are spaced by m image frames, wherein m is determined based on a quantity of frames in which dirty spots occur in successive image frames, and m is an integer greater than or equal to 0.

22. The method according to claim 20, wherein the determining whether there is the dirty spot in the current image frame according to the similarity of the corresponding one of the filtered image frames to the current image frame, the similarity of the corresponding one of the filtered image frames to the front reference frame corresponding to the current image frame and the similarity of the corresponding one of the filtered image frames to the back reference frame corresponding to the current image frame, comprises:
determining a maximum similarity from the similarity of the corresponding one of the filtered image frames to the front reference frame and the similarity of the corresponding one of the filtered image frames to the back reference frame; and
determining whether there is the dirty spot in the current image frame according to a comparison result of the maximum similarity and the similarity of the corresponding one of the filtered image frames to the current image frame.

23. The method according to claim 22, wherein the determining whether there is the dirty spot in the current image frame according to the comparison result of the maximum similarity and the similarity of the corresponding one of the filtered image frames to the current image frame, comprises:
in response to the similarity of the corresponding one of the filtered image frames to the current image frame being less than the maximum similarity, determining there is the dirty spot in the current image frame; or
in response to the similarity of the corresponding one of the filtered image frames to the current image frame being greater than or equal to the maximum similarity, determining there is no dirty spot in the current image frame.

24. The method according to claim 22, wherein
in response to the front reference frame being a plurality of continuous image frames before the current image frame in the video, determining the maximum similarity from the similarity of the corresponding one of the filtered image frames to each front reference frame and the similarity of the corresponding one of the filtered image frames to the back reference frame; or
in response to the back reference frame being a plurality of continuous image frames after the current image frame in the video, determining the maximum similarity from the similarity of the corresponding one of the filtered image frames to the front reference frame and the similarity of the corresponding one of the filtered image frames to each back reference frame; or
in response to the front reference frame being a plurality of continuous image frames before the current image frame in the video, and the back reference frame being a plurality of continuous image frames after the current image frame in the video, determining the maximum similarity from the similarity of the corresponding one of the filtered image frames to each front reference frame and the similarity of the corresponding one of the filtered image frames to each back reference frame.

25. The method according to claim 20, wherein in response to there being the dirty spot in the current image frame, the method further comprises:
obtaining a binary image according to a comparison result of the similarity of the corresponding one of the filtered image frames to the current image frame and a similarity threshold, wherein the binary image is configured for representing a mask image of the dirty spot in the current image frame; and
repairing the dirty spot in the current image frame according to the binary image and a reference frame corresponding to the current image frame.

26. The method according to claim 25, wherein the repairing the dirty spot in the current image frame according to the binary image and the reference frame corresponding to the current image frame, comprises:
inverting the binary image to obtain an inverted image;
determining a first image matrix according to a product of the reference frame corresponding to the current image frame and the binary image, and determining a second image matrix according to a product of the current image frame and the inverted image; and
determining an image frame after repairing the dirty spot in the current image frame according to the first image matrix and the second image matrix.

27. The method according to claim 25, wherein the reference frame corresponding to the current image frame comprises a reference frame corresponding to a maximum similarity of the similarity of the corresponding one of the filtered image frames to the front reference frame corresponding to the current image frame and the similarity of the corresponding one of the filtered image frames to the back reference frame corresponding to the current image frame.

28. The method according to claim 25, wherein after obtaining the binary image according to the comparison result of the similarity of the corresponding one of the filtered image frames to the current image frame and the similarity threshold, the method further comprises:
denoising the binary image at least once to obtain a processed binary image to repair the dirty spot in the current image frame according to the processed binary image and the reference frame corresponding to the current image frame; wherein the denoising comprises a corrosion process and/or an expansion process.

29. The method according to claim 20, wherein before filtering the current image frame, the front reference frame corresponding to the current image frame and the back reference frame corresponding to the current image frame to obtain the filtered image frames, the method further comprises:
cutting the current image frame into a plurality of current image blocks, cutting the front reference frame into a plurality of front reference blocks, and cutting the back reference frame into a plurality of back reference blocks;
the filtering the current image frame, the front reference frame corresponding to the current image frame and the back reference frame corresponding to the current image frame to obtain the filtered image frames, determining whether there is the dirty spot in the current image frame according to the similarity of the corresponding one of the filtered image frames to the current image frame, the similarity of the corresponding one of the filtered image frames to the front reference frame corresponding to the current image frame and the similarity of the corresponding one of the filtered image frames to the back reference frame corresponding to the current image frame, comprises:
for each current image block, filtering the current image block, the front reference block corresponding to the current image block and the back reference block corresponding to the current image block by using a filtering algorithm, to obtain filtered image blocks; and
determining whether there is the dirty spot in the current image block according to a similarity of a corresponding one of the filtered image blocks to the current image block, a similarity of a corresponding one of the filtered image blocks to the front reference block and a similarity of a corresponding one of the filtered image blocks to the back reference block.

30. The method according to claim 29, wherein the determining whether there is the dirty spot in the current image block according to the similarity of the corresponding one of the filtered image blocks to the current image block, the similarity of the corresponding one of the filtered image blocks to the front reference block and the similarity of the corresponding one of the filtered image blocks to the back reference block, comprises:
determining a maximum similarity from the similarity of the corresponding one of the filtered image blocks to the front reference block and the similarity of the corresponding one of the filtered image blocks to the back reference block; and
determining whether there is the dirty spot in the current image block according to a comparison result of the maximum similarity and the similarity of the corresponding one of the filtered image blocks to the current image block.

31. The method according to claim 29, wherein
two current image blocks closest to each other in a preset direction partially overlap, two front reference blocks closest to each other in the preset direction partially overlap, and two back reference blocks closest to each other in the preset direction partially overlap; and the preset direction comprises a horizontal axis direction or a vertical axis direction.

32. The method according to claim 29, wherein the cutting the current image frame into the plurality of current image blocks, cutting the front reference frame into the plurality of front reference blocks, and cutting the back reference frame into the plurality of back reference blocks, comprises:
traversing the current image frame, the back reference frame and the back reference frame respectively by using a preset window according to a preset step size, and cutting out the plurality of current image blocks of a size same as a size of the preset window, the plurality of front reference blocks of a size same as the size of the preset window and the plurality of back reference blocks of a size same as the size of the preset window;
wherein the preset step size comprises a horizontal step size in a horizontal direction and a vertical step size in a vertical direction, the horizontal step size is less than or equal to a width of the preset window, and the vertical step size is less than or equal to a height of the preset window.

33. The method according to claim 29, wherein in response to there being dirty spot in the current image block, the method further comprises:
obtaining a binary image block according to a comparison result of the similarity of the corresponding one of the filtered image blocks to the current image block and a similarity threshold, wherein the binary image block is configured for representing a mask image of the dirty spot in the current image block;
repairing the dirty spot in the current image block according to the binary image block and a reference block corresponding to the current image block to obtain a repaired image block, wherein the reference block is determined according to an image block of a position same as a position of the current image block in the reference frame corresponding to the current image frame; and
replacing the current image block with the repaired image block.

34. The method according to claim 20, wherein the filtering the current image frame, the front reference frame corresponding to the current image frame and the back reference frame corresponding to the current image frame to obtain the filtered image frames, comprises:
filtering the current image frame, the front reference frame corresponding to the current image frame and the back reference frame corresponding to the current image frame by using a filtering algorithm to obtain the filtered image frames;
wherein the filtering algorithm comprises a time median filtering algorithm, and the time median filtering algorithm is configured for obtaining a median value of pixel values at the same position in a plurality frames of images; or
the filtering algorithm comprises a time mode filtering algorithm, and the time mode filtering algorithm is configured for obtaining same pixel values of a largest quantity from pixel values at the same position in a plurality frames of images.

35. The method according to claim 20, wherein the similarity is configured for representing a correlation between pixels of different image frames, or a correlation between pixels of image blocks at a same position in different image frames;
the similarity comprises a structural similarity and/or an average structural similarity.

36. A device for detecting a dirty spot in a video, comprising a processor and a memory, wherein the memory is configured to store programs executable by the processor, and the processor is configured to read the programs in the memory and perform following steps:
in response to a user's input operation of at least one of a time parameter, a similarity parameter, a similarity threshold, a preset window size, or a preset step size, and detecting the dirty spot in an image frame in the video according to parameters corresponding to the input operation based on any of the methods according to claim 20;
wherein the time parameter represents a quantity of frames between the current image frame and the reference frame of the current image frame; the similarity parameter represents a range of a local area that affects a structural similarity of pixels at the same position in two image frames when calculating an average structural similarity by using the structural similarity of pixels at the same position in two image frames.

37. An electronic device, comprising a processor and a memory, wherein the memory is configured to store programs executable by the processor, and the processor is configured to read the programs in the memory and perform steps of any one of the methods according to claim 20.

38. A non-transitory computer storage medium, in which computer programs are stored, wherein steps of any one of the methods according to claim 20 are implemented when the computer programs are executed by a processor.
